(19) United States
(12) Patent Application Publication
(10) Pub. No.: US 2025/0391900 A1
(43) Pub. Date: Dec. 25, 2025

(54) INSPECTION PROCESS IN THE PRODUCTION OF MODULES OR PRECURSORS OF MODULES

(71) Applicant: MB Automation GmbH & Co. KG, Roding (DE)

(72) Inventors: Ondrej Vasko, Schwandorf (DE); Jessica Mayer, Dieterskirchen (DE)

(21) Appl. No.: 18/842,990

(22) PCT Filed: May 3, 2023
(86) PCT No.: PCT/EP2023/061603

§ 371 Date: Apr. 15, 2025

(30) Foreign Application Priority Data
May 12, 2022 (DE) 102022111907.6

(51) Int. Cl. H01M 10/04

(52) U.S. Cl. CPC H01M 10/0404; H01M 10/0463

(57) ABSTRACT

An inspection in the manufacture of modules or pre-stages of modules, comprises: providing a separated anode/cathode layer at a pick-up location; conveying a stacking apparatus to the pick-up location; picking up the anode/cathode layer from the pick-up location by the stacking apparatus; detecting the position and/or orientation of the anode/cathode layer; transporting the anode/cathode layer to a stacking location by the stacking apparatus; aligning the stacking apparatus with the transported anode/cathode layer relative to the stacking location; and stacking the transported anode/cathode layer at the stacking location.

### BACKGROUND

An inspection during the production of modules or precursors of modules is disclosed here. These modules or their precursors can be, for example, layer arrangements containing layer material, arrangements for fuel or battery cells, or parts for their production. This inspection is disclosed as a method and as an apparatus. Details are defined in the claims. The description also contains relevant information on the structure and function of the inspection as well as on apparatus and process variants.

### STATE OF THE ART

WO 2021 171 946 A1 relates to a testing apparatus for testing the position of the electrode layer in a laminate, in which a release film and an electrode layer are bonded by an adhesive, from the release film side. An infrared irradiation unit irradiates the laminate with infrared light from the release film side. A camera sensitive to infrared light records the infrared light transmitted through the release film and reflected by the electrode layer. A detection unit records the position of the electrode layer based on the image captured by the camera. Stacks of laminate consisting of release films and electrode layer are stacked on a stacking table. A transport unit is used to transport the release films and electrode layer and to place them on the stacking table. The testing apparatus checks the position of the electrode layer in the laminate stack released by the transport unit.

In other known solutions, the finished battery cell, and in precursors the electrode stacks, are tested for electrical short circuits. This procedure leads to a vertical proportion of unusable (intermediate and final) products, as even non-precisely manufactured electrode stacks are laminated and then finally processed into an inadequate battery cell.

### Technical Problem

Based on this, an apparatus and a procedure are to be provided which allow modules or precursors of modules, for example fuel or battery cells containing layer material, to be produced at vertical precision with vertical processing speed, reduce their short-circuit risk and improve their efficiency.

### Technical Solution

An inspection process in the manufacture of modules or precursors of modules comprises the steps, for example in the following sequence:

providing a separated anode and/or cathode layer at a pick-up point; conveying a stacking apparatus to the pick-up point; picking up the anode/cathode layer from the pick-up point by the stacking apparatus; detecting the position and/or orientation of the anode/cathode layer; transporting the anode/cathode layer to a stacking location by the stacking apparatus; aligning the stacking apparatus with the transported anode/cathode layer relative to the stacking location; and stacking the trans ported anode/cathode layer at the stacking location.

In variants of the inspection method, the position and/or orientation of the anode/cathode layer is recorded before the anode/cathode layer is picked up by the stacking apparatus from the pick-up point and/or during the transport of the anode/cathode layer by the stacking apparatus to the stacking point. In variants of the inspection method, the position and/or orientation of the anode/cathode layer is detected during the transport of the anode/cathode layer by the stacking apparatus to the stacking point by means of a first camera and/or before the anode/cathode layer is picked up by the stacking apparatus from the pick-up point by means of a second camera.

To ensure precise positioning, in a variant a preliminary position is first checked on the transport of the incoming anode/cathode layers with the aid of a matrix camera and an illumination apparatus (white, adjustable 0-20°).

In variants of the inspection method, the first and/or the second camera detect the position and/or orientation of the anode/cathode layer in a vertical, ± approximately 25°, top view of the anode/cathode layer. In variants of the inspection method, a white light source assigned to the first and/or second camera illuminates the anode/cathode position for image capture by the first and/or second camera. In variants of the inspection method, the first and/or the second camera completely capture the anode/cathode position with a (single) image feed in order to detect its position and/or orientation. In variants of the inspection method, the first and/or the second camera capture an area, at least one corner area, two diagonal corner areas, and/or at least one corner area and at least a section of an edge of the anode/cathode layer with a single image feed in order to detect the position and/or orientation of the anode/cathode layer. In variants of the inspection method, the first and/or the second camera are designed as line scan cameras, which detect the position and/or orientation of the anode/cathode layer before it is picked up by the stacking apparatus or when it arrives at the pick-up point or on the way to the pick-up point.

In variants of the inspection method, at least one optically effective element is mounted upstream of the first and/or second camera in order to detect the position and/or orientation of the anode/cathode layer at one or more points or areas before it is picked up by the stacking apparatus or when it arrives at the pick-up point or on the way to the pick-up point.

In variants of the inspection method, correction values are determined from the position and/or orientation of the anode/cathode layer before it is picked up by the stacking apparatus, the position and/or orientation of the stacking apparatus, and/or the position and/or orientation of the individual anode/cathode layer picked up during a transport of the anode/cathode layer to the stacking location. In variants of the inspection method, these correction values are taken into account when aligning the stacking apparatus with the transported anode/cathode layer relative to the stacking location. In variants of the inspection method, these correction values are taken into account when aligning the stacking apparatus for picking up the anode/cathode layer by the stacking apparatus in such a way that the anode/cathode layer is picked up by the stacking apparatus in a centered zero position and/or in an aligned orientation.

In a variant of the inspection method, the calculated correction values can be used to position the stacking apparatus relative to the anode/cathode layer before/when it is picked up in such a way that the anode/cathode layer is picked up by the stacking apparatus in a zero position. For this purpose, the stacking apparatus can be corrected in its position and/or orientation relative to the anode/cathode position at the pick-up point.

Similarly, after picking up during transport, the stacking apparatus can be positioned according to the correction values from the image feed so that the anode/cathode layer is deposited by the stacking apparatus at the stacking point on the electrode stack located there in a suitable manner and with minimal or no further correction movement.

This process can be carried out very fast and with vertical precision. An apparatus described below, for example, is suitable for carrying out this process.

An apparatus for conveying and inspecting modules or precursors of modules comprises: a stacking apparatus, intended and arranged for picking up a combined anode/cathode layer at a pick-up point; a conveyor apparatus, intended and a directed for conveying the stacking apparatus towards the pick-up point and away from the pick-up point; a first camera, intended and arranged for detecting the position and/or orientation of the anode/cathode layer on its path from the pick-up point to the stacking point; an actuating apparatus, comprising at least one actuator, intended and arranged for actuating the stacking apparatus for picking up the anode/cathode layer, and/or for aligning the stacking apparatus with the anode/cathode layer relative to the stacking point during the transport of the anode/cathode layer to the stacking point, and/or for stacking the anode/cathode layer at the stacking point.

In variants of the apparatus, a first camera is intended and arranged to detect the position and/or orientation of the anode/cathode layer during the transport of the anode/cathode layer by the stacking apparatus to the stacking location. In variants of the apparatus, a second camera is intended and arranged to detect the position and/or orientation of the anode/cathode layer before the anode/cathode layer is picked up from the pick-up point by the stacking apparatus.

In variants of the apparatus, the first and/or the second camera are intended and arranged to detect the position and/or orientation of the anode/cathode position in a vertical, ± approximately 25°, top view of the anode/cathode position. In variants of the apparatus, a white light source associated with the first and/or the second camera is intended and arranged to detect the anode/cathode position for image capture by the first and/or second camera. In variants of the apparatus, the first and/or the second camera are intended and arranged to detect the anode/cathode position fully continuously with a (single) image capture in order to detect its position and/or orientation. In variants of the apparatus, the first and/or the second camera are intended and arranged to detect an area, at least one corner area, two diagonal corner areas, and/or at least one corner area and at least a section of an edge of the anode/cathode layer with a single image feed, in order to detect the position and/or orientation of the anode/cathode layer.

In variants of the apparatus, the first and/or the second camera are designed as a line scan camera, which are intended and arranged to detect the position and/or orientation of the anode/cathode layer before it is picked up by the stacking apparatus or when it arrives at the pick-up point or on the way to the pick-up point. In variants of the apparatus, at least one optically active element is mounted upstream of the first and/or the second camera and is intended and arranged to detect the position and/or orientation of the anode/cathode layer at one or more points or areas before it is picked up by the stacking apparatus or when it arrives at the pick-up point or on the way to the pick-up point. In variants of the apparatus the at least one optically active element is a lens or lens arrangement, a mirror or a mirror arrangement, a prism or a prism arrangement, an area light, a coaxial ring light, a dark-field light, or combinations thereof.

In variants of the apparatus, a control unit is intended and arranged to determine correction values from the image capture and/or data from the acquisition apparatus and/or the first and/or the second camera from the position and/or orientation of the anode/cathode layer before it is picked up by a stacking apparatus, the position and/or orientation of the stacking apparatus, and/or the position and/or orientation of the individual anode/cathode layer picked up on relative to the stacking apparatus during a transport of the anode/cathode layer to the stacking location. In variants of the apparatus, the control unit is intended and arranged to take these correction values into account in positioning commands to the positioning apparatus, the conveyor apparatus and/or the stacking apparatus when aligning the stacking apparatus with the transported anode/cathode layer relative to the stacking point. In variants of the apparatus, a control unit is intended and arranged to take into account these correction values for the alignment and the location of the stacking apparatus when picking up the anode/cathode layer in positioning commands to the positioning apparatus, the conveying apparatus and/or the stacking apparatus in such a way that the stacking apparatus picks up the respective anode/cathode layer in a centered zero position and/or aligned with the electrode stack located at the stacking location.

By checking the position of the incoming anode/cathode layer before or in the pick-up point, the alignment and location of the stacking apparatus can be precisely determined during or before the anode/cathode layer is picked up. This allows the anode/cathode layer to be picked up by the stacking apparatus in a precisely coordinated and controlled manner. In a variant, a further check of the alignment and location of the lifted individual anode/cathode layer takes place during the conveying of the stacking apparatus into the stacking point, which additionally increases the precision of the placement of the individual anode/cathode layer on the stack of electrodes at the stacking point.

A further inspection process in the manufacture of modules or precursors of modules du comprises the steps, for example in the following sequence: Providing a combined anode/cathode layer; transporting the anode/cathode layer to a stacking station by a stacking apparatus; stacking the transported anode/cathode layer at the stacking station; detecting a stack of electrodes grown around the stacked anode/cathode layer at the stacking location in at least one side view and/or a vertical edge of the stack of electrodes at the stacking location; and checking the orientation and/or position of the or each stacked anode/cathode layer relative to the rest of the stack of electrodes grown at the stacking location.

This procedure allows the exact position of the top layer to be determined in relation to the other layers of the electrode stack. This check becomes increasingly important as the height of the electrode stack increases, as incorrectly positioned placement of the top layer must lead to the electrode stack being discarded without further correction. However, the inspection becomes increasingly accurate as the height of the electrode stack increases, as the geometric areas to be measured (corner or vertical edge of the electrode stack) can be detected and analysed more easily and precisely.

In a variant of the process, this also allows more precise correction values to be calculated when placing the next layer on the stack of electro den. Overall, this procedure with the precise position check allows a considerable reduction in the risk of short circuits, for example in the fuel or battery cells.

This also becomes clear from the fact that previous solutions only deposit the layers with an accuracy of ±0.5 mm, whereas the solution presented here allows an accuracy of ±0.1 mm and more when depositing the anode/cathode layers on the electrode stack in order to reduce waste and improve efficiency.

After placing the anode/cathode layers on the electrode stack, the position/offset of the individual layers in relation to each other is checked and, as a result, whether/with what deviation in the longitudinal or transverse direction the individual layers of the entire electrode stack are aligned with each other. In a variant, an offset of the individual layers relative to each other is analysed with a (single) image capture by at least a third camera of at least one (vertical and/or transverse) edge of the electrode stack (grown up to the current image capture n). By analysing the image indentation obtained using image processing at means (corner/edge search, etc), it is possible to check whether one or more layers of the electrode stack are protruding or not protruding in the longitudinal or transverse direction relative to the other layers, and whether a pre-specified accuracy was maintained when stacking the anode/cathode layers in relation to one another. The anode layers and cathode layers of the electrode stack, which are stacked alternately on top of each other, have different dimensions, resulting in a stepped (raised) edge in the side view, which must be processed (image) accordingly. The deviation with which each individual layer (laterally) protrudes above/below the usual anode or cathode layers can be relevant. It may also be relevant that the different anode/cathode layers always form equally vertical stu tions in the entire electrode stack. The latter is evidence that the individual anode/cathode layers have been stacked without folds or creases.

For this purpose, in a variant of the method, alternately stacked anode layers and cathode layers of the electrode stack, which have different dimensions with a (vertical) edge stepped in the z-direction in the side view, are examined for their shape and/or dimension. In a variant of the method, anode layers and cathode layers of the electrode stack stacked on top of each other alternately are examined, with which deviation each individual layer (laterally) protrudes above/below the other anode or cathode layers of the electrode stack. In a variant of the procedure, the deviation in the z-direction (vertical axis) with which the various anode/cathode layers form steps in the electrode stack is determined.

In a variant of the method, two third matrix cameras are used, which (viewed from above) are aimed at diagonally opposite corners/(vertical) edges of the electrode stack at the deposit point. In a variant of the method, the cameras are set to the respective edge of the electrode den stack. In a variant of the process driving the respective edge of the electrode stack, (white) spot lights are used to illuminate the desired position.

In a variant of the method, four third matrix cameras are used, which (viewed from above) are directed at all four corners/(vertical) edges of the electrode stack at the deposit site. In a variant of the method, backlighting or darkfield illumination is achieved by means of respective light sources. This allows the relevant areas of the various anode/cathode layers to be easily recognised in transmitted light. In a variant of the process, mirrors or prisms are used to guide the beam path of the third cameras for adaptation to spatial conditions.

In a variant of the method, a third matrix camera is used with a field of view of the electrode stack from above, which captures the electrode stack as a whole completely in one image feed, or two third matrix cameras, each of which captures one of two diagonal corners of the electrode stack from above, up to four third matrix cameras, which capture all four corners of the electrode stack from above and which are directed in the top view onto the electrode stack at the deposit point. Here too, in a variant, the beam path of the cameras is guided by appropriate arrangements of mirrors or prisms for adaptation to spatial conditions. In a variant, a coaxial (red) light and a (white) spotlight are used for the lighting for each of the third cameras.

This makes it possible to recognise very precisely that the anode/cathode layers are always placed in the correct position on the electrode stack.

In a variant of the method, the movements of the lifting apparatus with the respective workpiece carrier along the vertical axis (z-axis) and their inaccuracies are also taken into account by using the third cameras to record the x, y positions of the workpiece carrier at different z heights before the start of depositing the anode/cathode layers to form the electrode stack. In this way, the third cameras can be used to check whether the anode/cathode layers have been stacked at the correct x, y position, which corresponds to the respective z position of the workpiece carrier on the lifting apparatus, while the anode/cathode layers are being stacked. The accuracy in the direction of rotation around the vertical axis (in theta) when picking up the anode/cathode layers with the stacking apparatus can also be corrected in this way for subsequent precise stacking of the anode/cathode layers of the electrode stack.

An apparatus for conveying and inspecting modules or precursors of modules is equipped with a pick-up point for providing a separated anode/cathode layer; a stacking apparatus, intended and arranged for transporting the anode/cathode layer to a stacking point; for stacking the transported anode/cathode layer at the stacking point; a camera, intended and arranged to capture an image feed of an electrode stack grown around the stacked anode/cathode layer at the stacking point in at least one side view and/or including a vertical edge in the z-direction of the electrode stack at the stacking point; and a control unit, intended and arranged to determine from the image feed of the second camera the orientation and/or position of the or each stacked anode/cathode layer relative to the rest of the electrode stack grown at the stacking point.

In a variant of the apparatus, the control unit is intended and arranged to determine a position of a stacked anode/cathode layer in relation to the other layers of the electrode stack by checking the position/rotation/offset of the individual anode/cathode layers in relation to one another after the anode/cathode layers have been placed on the electrode stack, and/or wherein the control unit is intended and arranged to determine an offset of the individual anode/cathode layers relative to one another with an image capture of at least one third camera from at least one (vertical and/or transverse) edge of the electrode stack. In a variant of the apparatus, the control unit is intended and arranged to check a resulting image indentation by corner/edge search to determine whether one or more of the anode/cathode layers of the electrode stack are above or below the other anode/cathode layers, and/or whether an accuracy was maintained when stacking the anode/cathode layers.

In a variant of the apparatus, the control unit is intended and arranged to determine different dimensions with a (vertical) edge stepped in the z-direction in the view from the image feed in alternating stacked anode layers and cathode layers of the electrode stack, and to examine the stacked anode layers and cathode layers for their shape and/or dimensions. In a variant of the apparatus, the control unit is intended and arranged to examine the anode layers and cathode layers stacked on top of each other to determine the deviation from the other anode or cathode layers of the electrode stack with which each individual layer is above/below. In a variant of the apparatus, the control unit is intended and arranged to analyse an image indentation to determine the deviation in the z-direction (vertical axis) with which the various anode/cathode layers form steps in the electrode stack.

In a variant of the apparatus, the control unit is intended and arranged to receive image captures from at least two third cameras, which contain diagonally opposite corners and/or their edges in the vertical axis (z-axis) of the electrode stack ES at the deposit location, as seen from the side, in order to examine, on the anode layers and cathode layers stacked on top of one another, the deviation in the x or y direction (transverse, longitudinal) with which the various anode layers and cathode layers of the electrode stack protrude/deflect in the longitudinal and/or transverse direction of the layers; and/or to examine the deviation in the z direction (vertical axis) with which the various anode layers and cathode layers of the electrode stack protrude/deflect in the longitudinal and/or transverse direction of the layers. layers of the electrode stack; and/or to investigate the deviation in the z-direction (vertical axis) with which the various anode/cathode layers form steps in the electrode stack.

In a variant of the apparatus, the at least two third cameras are aligned with a (vertical) edge of the electrode stack and/or (white) spotlights are used to illuminate the respective edge of the electrode stack to illuminate the desired position on the electrode stack.

In a variant of the apparatus, the control unit is intended and arranged to receive image feeds from at least four third cameras, which contain the four corners of the electrode stack at the deposit location as seen from above, in order to determine a position of the top most stacked anode/cathode layer in relation to at least one underlying layer of the electrode stack by checking the position/rotation/offset of the individual anode/cathode layers relative to one another by means of an image feed from each of the four cameras after the anode/cathode layers have been deposited on the electrode stack.

In a variant of the apparatus, the control unit is intended and arranged to take account of we movements of the lifting apparatus with the respective workpiece carrier along the vertical axis (z-axis) and their inaccuracies by detecting the x-, y-positions of the work piece carrier at different z-heights with the third cameras by means of image feeds before the start of depositing the anode/cathode layers to form the electrode stack, storing the corresponding data in a data memory for comparison with x-, y-positions of the workpiece carrier at different z-heights during the depositing of the anode/cathode layers in order to check whether the anode/cathode den layers have been stacked within the accuracy at the x-, y-position, which corresponds to the z-position of the workpiece carrier on the lifting apparatus, and/or for correcting the orientation in the direction of rotation around the z-axis (vertical axis) (in theta) when picking up the anode/cathode layers with the stacking apparatus.

The procedures and apparatuses described above allow a significant reduction in the risk of short circuits in the module thus formed, which also leads to an increase in the overall quality and efficiency of the fuel or battery cell.

Overall, the apparatus and process described above allows an accuracy of ±0.1 mm or more with a vertical stack throughput.

Process aspects are presented above in apparatus terms and vice versa. Both the process aspects and the apparatus aspects serve to explain the apparatus and its operation.

### BRIEF DESCRIPTION OF THE FIGURES

Further features, properties and advantages of the apparatuses and methods can be found in the following description in conjunction with the drawing. Possible variations will become clear to a person skilled in the art from the following description, in which reference is made to the accompanying drawings. The figures show schematically the apparatuses discussed here and explain their operation. They show:

FIG. 1 schematic top view of an assembly line with inspection during the production of modules or precursors of modules;

FIG. 1a a second camera arrangement for inspecting the layers before they are picked up by the stacking apparatus;

FIG. 2 is a schematic side view of a process station designed as a stacking unit of the assembly line from FIG. 1;

FIG. 2a a first variant of a second camera arrangement for inspecting the layers during transport from the pick-up point to the stacking point by means of the stacking apparatus;

FIG. 2b a second variant of a second camera arrangement for inspecting the layers during transport from the pick-up point to the stacking point by means of the stacking apparatus;

FIG. 3 a variant of a third camera arrangement in a side view for inspecting the layers of a stack of electrodes after they have been stacked at the stacking point by means of the stacking apparatus; and

FIG. 3a is a top view of the variant of the third camera arrangement from FIG. 3.

### DETAILED DESCRIPTION OF VARIANTS OF THE APPARATUSES AND PROCESSES

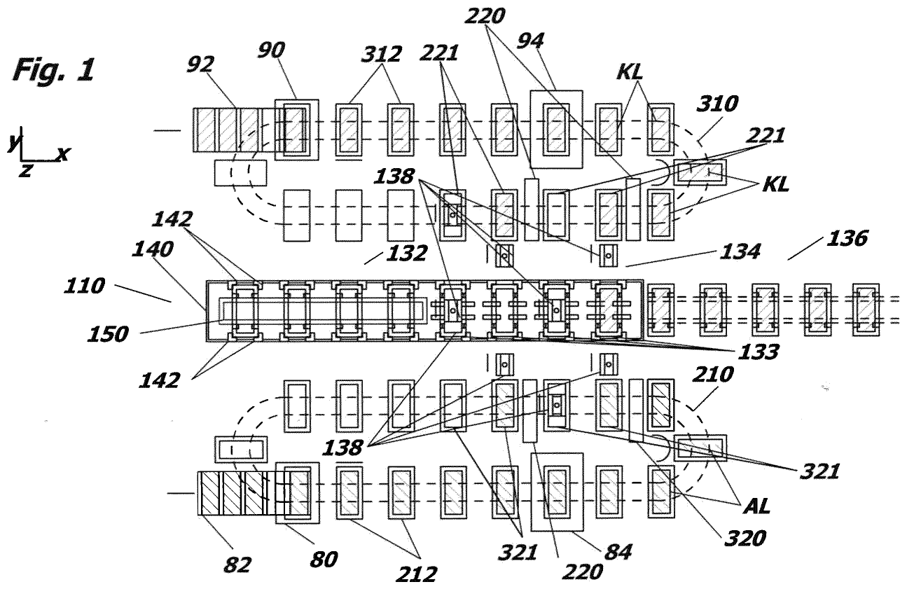

FIG. 1 schematically illustrates a part of an assembly line 100 for the manufacture of modules or precursors of modules. Here, the assembly line 100 is explained by way of example using the manufacture of fuel or battery cells containing layer material and/or fluid. A central transport section 110 conveys a plurality of workpiece carriers 120 between several process stations. The central transport section 110 is set up by means of drives, not shown further, to convey the workpiece carriers 120 in groups in individual transport sections.

As supply stations to the assembly line 100, a first cutting or punching station, not shown further, is set up to divide a first endless layer material coming from a roll into uniform rectangular pieces and to deliver it onto a carrier 82 as a sequence of separated anode layers AL. A second cutting or punching station, not shown further, is set up to cut a second continuous layer material coming from a roll into uniform rectangular pieces and to deliver it onto a carrier 92 as a sequence of separated cathode layers KL. A first depositing station 80 feeds the separated anode layers AL onto transportable adhesive trays 212 of a first transport section 210 in order to feed them to a stacking unit 138. A second depositing station 90 feeds the separated cathode layers KL onto transportable adhesive trays 312 of a second transport port route 310 in order to feed them to a stack unit 138. On their transport to the stacking unit 130, the anode and cathode layers AL, KL are guided through an inspection station 84, 94 assigned to the respective transport line 210, 310 in order to check their quality. In a variant, the cathode is a metal foil with a conductive coating on both sides and a protruding conductor tab. In a variant, the anode is a metal foil with a conductive coating on both sides, which is laminated between two dielectric foils (separators), with the current conductor tab protruding laterally, i.e. on one of the short sides between the separators.

Such an assembly line 100 has a first transport section 116 with the pick-up area 132, the stacking area 134 and the delivery area 136. Several, for example four, first lifting apparatuses 135 are provided in the stacking area 134 in order to lift workpiece carriers 120 off the carriage 140 in the Z direction. The carriage 140 can be positioned in and against the outward path 112 along a first transport section 116. The slide 140 is set up to position several empty workpiece carriers 120 in groups from the pick-up area 132 into the stacking area 134 and/or several workpiece carriers, each carrying a stack created in the stacking area 134, from the stacking area 134 into the delivery area 136. Each lifting apparatus 135 is set up to raise and lower the respective workpiece carrier 120 for stacking by the carriage 140 in a controlled manner. In the conveying direction (x-direction) of the workpiece carriers 120, the carriage 140 has a length that at least approximately corresponds to the extension of the pick-up area 132 and the stack area 134, or the stack area 134 and the discharge area 136 in the conveying direction of the work piece carriers 120. The carriage 140 is arranged to move longitudinally on two linear guides and has 2×N holders 142 on each longitudinal side for N workpiece carriers 120 to be positioned. The lifting apparatuses 135 extend between the linear guides and can thus lift the N workpiece carriers 120 at their respective x, y position while remaining in the z direction, while the carriage 140 is moved along the linear guides (in the x direction). Similarly, the lifting apparatus 150 is provided in the pick-up area 132 for the N workpiece carriers 120 and a lifting apparatus is provided in the delivery area 136 in each case.

In the receiving area 132, several workpiece carriers 120—here as a group of four—can be removed from the central transport section 110 in the variant shown here. In other variants, more or fewer than four workpiece carriers 120 can also be removed from the central transport section 110. For this purpose, the central transport section 110 has a lifting apparatus 150 on the upstream side of the stacking unit 130 in the receiving area 132, which in a variant can be part of the central transport section 110, here in the form of a scissor lift table. The lifting apparatus 150 is designed to lift a group of four workpiece carriers 120 from the central transport section 110 in the receiving area 132 and place them on a carriage 140. In a variant, the carriage 140 can also be part of the central transport section 110. This carriage 140 in the stacking unit 130 is to be moved in and against the conveying direction x of the workpiece carriers 120 in a controlled manner by means of a drive, which is not further illustrated, in order to pick up the group of workpiece carriers 120 in the pick-up area 132, to convey it from the pick-up area 132 into a stacking area 134, and from the stacking area 134 into a delivery area 136.

In the stacking area 134, individual anode layers AL and individual cathode layers KL are transported into the stacking area 134 with a number of stacking apparatuses 138 (here four) corresponding to the number of workpiece carriers 120 in the group from a respective first and second transport section 210, 310 located on both longitudinal sides of the central transport section 110 with vacuum or adhesive trays 212, 312, also referred to as shuttles (see also FIG. 1). In other words, two stacking apparatuses 138 are assigned to each workpiece carrier 120 in the stacking area 134. For this purpose, the arrangement of the stacking apparatuses 138 is equipped with respective drives, which are not further illustrated, in order to move the stacking apparatuses 138 individually vertically in the z-direction for raising and lowering the individual anode and cathode layers KL. In the variant shown here, the transport sections 210, 310 are each endless transport sections and are set up to convey the vacuum or adhesive trays 212, 312 in a horizontal conveying plane along a closed path.

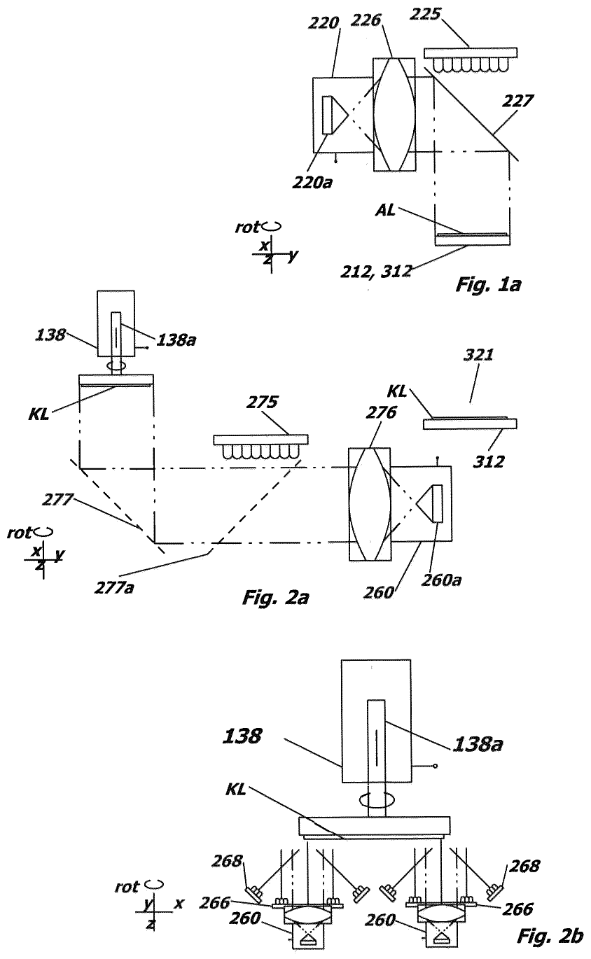

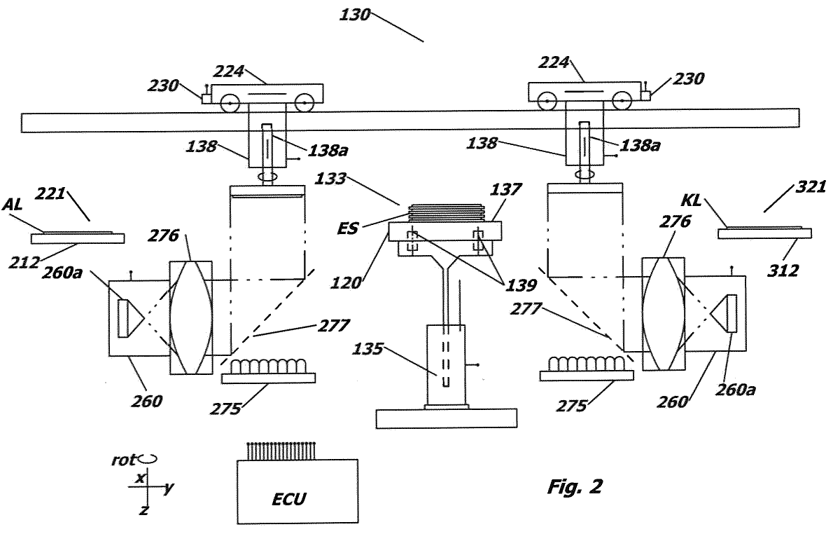

Further drives 224 illustrated below in connection with FIG. 2 serve to move the stacking apparatuses 138 individually horizontally in the y-direction, transversely to the central transport section 110, in order to transport the individual anode and cathode layers AL, KL from the trays of the first and second transport sections 210, 310 to the respective stacking point 133 on the workpiece carrier 120 in the stacking area 134. In the process, individual anode layers AL from a first side of the workpiece carrier 120 and individual cathode layers KL from a second side of the workpiece carrier 120 are alternately brought to the respective workpiece carrier 120 and stacked to form an electrode stack ES on the respective workpiece carrier 120 on the workpiece carrier 120 taken from the central transport section 110. The assembly line 100/the stacking unit 130 according to FIG. 1 comprises, by way of example, 4 stacking lines 133. The stacking unit 130 also has several first lifting apparatuses 135 acting in the z-direction, one for each workpiece carrier 120, in order to lift the workpiece carriers 120 from the carriage 140 in the z-direction in a controlled manner and thus separate them from the carriage 140, and to place these workpiece carrier(s) 120 on the carriage 140 in the z-direction in a controlled manner. This allows the workpiece carriers 120 to be loaded with the layer material for forming the stack of electrodes ES, while the carriage 140 can be moved back and forth in the x-direction.

At each stacking point 133, a flat holder 137 with a positioning pin 139 is provided, which receives an empty workpiece carrier 120 and holds it in the correct position (see FIG. 2).

In FIG. 2, a workpiece carrier 120 located in the stacking unit 130 on one of the first lifting apparatuses 135 is shown, which is lifted out of the carriage 140 not shown and is located at a stacking point 133. At this stacking point 133, the empty workpiece carrier 120 is filled as described below and then returned to the central transport section 110 for conveying to a subsequent process station. As described above, the first lifting apparatus 135 serves to remove the at least one empty work piece carrier 120 from the central transport section 110. At each stacking point 133, a stacking apparatus 138 transports the individual anode layers AL (left in FIG. 2) and a stacking apparatus 138 transports the individual cathode layers KL (right in FIG. 2) alternately from both sides of the workpiece carrier 120 in and against the y-direction and stacks them on the workpiece carrier 120 in the z-direction. In this way, the electrode stack ES grows to the desired number of layers. In a variant, the workpiece carrier 120 is lowered after each anode layer AL or cathode layer in the z-direction by the height/thickness of an anode layer AL or cathode layer.

Each of the stacking apparatuses 138 is intended and arranged to pick up either the individual anode layers AL/the individual cathode layers KL by means of controlled pneumatic negative pressure and to hold them above the workpiece carrier 120 during transport to the stacking point 133. Each stacking apparatus 138 has a flat gripping tool which is to be pressurised with negative pressure for holding and transporting an anode/cathode layer AL, KL. In a variant, it is also provided to release the individual anode layers AL and the individual cathode layers KL at the stacking point 133 by means of a short controlled pneumatic overpressure shock in order to stack the layers AL, KL on the workpiece carrier 120.

In addition to conveying the layers AL, KL, the apparatus described here also serves to inspect the layers AL, KL on their way from their respective transport sections 210, 310 to the corresponding stacking point 133. For this purpose, the pick-up points 221, 321 are provided in the stacking area 134, to which the separated anode/cathode layers AL, KL are transported with the vacuum or adhesive trays 212, 312. Before the adhesive trays 212, 312 with the anode/cathode layers arrive at the corresponding stacking point 133, the anode/cathode layers AL, KL are captured by a second camera 220. This second camera 220 is used to detect the position and/or orientation, here in x, y and the ta, of the anode/cathode layer on its adhesive tray 212, 312 before the anode/cathode layers AL, KL are picked up from their adhesive tray 212, 312 by the stacking apparatus 138. An inspection of an anode layer AL or a cathode layer KL with the second camera 220 can be carried out while the vacuum or adhesive tray 212, 312 transporting the anode/cathode layer AL, KL to be inspected is moved along the closed path of the transport section 210, 310.

Alternatively, an inspection of an anode layer AL or a cathode layer KL can be carried out cathode layer KL can be carried out with the second camera 220 while the vacuum or adhesive tray 212, 312 transporting the anode/cathode layer AL, KL to be inspected is stationary (for a short time, a few milliseconds) and other vacuum or adhesive trays 212, 312 moving along the closed path of the transport section 210, 310, for example a vacuum or adhesive tray 212, 312 which is moving directly along the closed path before and/or after the vacuum or adhesive tray 212, 312 which is stationary (for a short time) for the inspection with the second camera 220, are moved along the closed path of the transport section 210, 310.

The second camera 220 is aligned in such a way that it can capture the position and/or orientation (in x, y, and/or theta) of the anode/cathode layer in a vertical top view during transport, shortly before the respective anode/cathode layer AL, KL arrives at its pick-up point 221, 321. In FIG. 2, two of the first cameras 220 for the anode layers AL and two for the cathode layers KL are view shown. It should be understood that a second camera 220 can also be provided in front of each recording location 221, 321, or only in front of the respective first recording location 221, 321. A white light source 225 is provided for each first camera 220 (see FIG. 1a) in order to illuminate the anode/cathode position for the image capture by the camera 220. From depending on the spatial conditions, the second camera 220—as also illustrated in FIG. 1a—is designed as a full-frame camera to completely capture the anode/cathode position AL, KL with a single image capture, or the second camera is designed as a line scan camera to capture the position and/or orientation of the anode/cathode position in x, y, and/or theta while it is transported to the corresponding recording location 221, 321. The full-frame camera can, for example, have a digital image capture chip 220a with 24 megapixels. Depending on the requirements for accuracy and resolution and the spatial conditions, the second camera 220 can also—with appropriate optics, for example a lens 226 and a 90° deflection mirror 227 that is semi-transparent for the white light—provide a full image capture from above onto the anode/cathode position.

A conveying apparatus 224 is associated with each stacking apparatus 138 for conveying the stacking apparatus 138 back and forth between the respective pick-up point 221, 321 and the stacking point 133. Thus, with a number of stacking apparatuses 138 (here four) corresponding to the number of workpiece carriers 120 in the group, individual anode layers AL and individual cathode layers KL are transported into the stacking area 134 from a respective first and second transport section 210, 310 located on both longitudinal sides of the central transport section 110 with vacuum or adhesive trays 212, 312, also referred to as shuttles (see also FIG. 1). In other words, two stacking apparatuses 138 are assigned to each workpiece carrier 120 in the stacking area 134. For this purpose, the arrangement of the stacking apparatuses 138 is equipped with respective actuating drives 138a in order to move the stacking apparatuses 138 individually vertically in the z-direction for raising and lowering the individual anode and Kathode layers KL. Further drives 224 are used to move the stacking apparatuses 138 individually horizontally in the y-direction, transverse to the central transport section 110, in order we to transport the individual anode and cathode layers AL, KL from the trays 211, 311 of the first and second transport sections 210, 310 to the respective stacking point 133.

In each case, a common horizontal linear guide is provided for two stacking apparatuses 138 and is arranged above a respective workpiece carrier positioned in the stacking area 134. The linear guide extends from a pick-up point of the transport section 210 to a pick-up point of the transport section 310 and spans the stack area 134.

Sensors 230 serve as a detection apparatus for detecting the position and/or orientation (in x, y, z, and/or theta) of the stacking apparatus 138. These sensors 230, of which only the position of the stacking apparatus 138 in the y-direction is illustrated here for the sake of clarity, supply corresponding data to a control unit ECU.

On the path from the pick-up point 221, 321 to the stacking point 133, each stacking apparatus 138 passes a first camera 260. This first camera 260 is used to detect the position and/or orientation (in x, y, z, and/or theta) of the anode/cathode layer AL, KL adhering to the underside of the stacking apparatus 138 relative to the position and/or orientation (in x, y, z, and/or theta) of the stacking apparatus 138 on its path to the stacking point 133. This data is fed to the control unit ECU and processed there in order to control the corresponding actuating apparatuses, for example the actuators 138a, 224, etc. These positioning apparatuses also include pneumatic actuators not illustrated further so that the stacking apparatus 138 can pick up and place the anode/cathode layers AL, KL, electric or pneumatic actuators to align the stacking apparatus 138 in x, y, z, and/or the ta, during the transport of the anode/cathode layer to the stack location 133, so that the anode/cathode layer AL, KL is optimally positioned for stacking relative to the stack location 133 and the stack of electrodes located there, and for stacking the anode/cathode layer at the stacking location 133.

The first camera 260 is used here to detect the position and/or orientation (in x, y, z, and/or theta) of the anode/cathode layer AL, KL relative to the stacking apparatus 138 before the anode/cathode layer AL, KL is stacked at the stacking point 133. This data is fed to the control unit ECU and processed there. The control unit ECU determines from the image feed and the data from the various detection apparatuses correction values. In particular, the position and/or orientation (in x, y, z, and/or theta) of the anode/cathode position AL, KL at the pick-up point or on the way to it before the pick-up by a stacking apparatus 138, the position and/or orientation (in x, y, z, and/or theta) of the stacking apparatus 138 at the pick-up point or on the way there, as well as the position and/or orientation (in x, y, z, and/or theta) of the individual anode/cathode layer taken on relative to the stacking apparatus 138 during transport of the anode/cathode layer to the stacking point 133, the correction values are determined. These correction values are used to align the stacking apparatus 138 with the transported anode/cathode layer relative to the stacking location 133 in x, y, z, and/or theta, so that the transported anode/cathode layer is deposited precisely at its target position relative to the electrode stack ES located at the stacking location 133. In other words, these correction values are taken into account when correcting the orientation and location (in x, y, z, and/or theta) of the stacking apparatus 138 when picking up the anode/cathode layer into positioning commands to the positioning apparatus, the conveyor 224 and/or the stacking apparatus 138 in such a way that the anode/cathode layer is picked up by the stacking apparatus 138, for example in a centered zero position or aligned with the stack of electrodes located at the stacking point 133.

The first camera 260 is aligned such that during the transport of the anode/cathode layer, its position and/or orientation (in x, y, and/or theta) is captured in a vertical right view from below with an image feed, shortly before the respective anode/cathode layer AL, KL arrives at its stacking location 133. FIG. 2 illustrates one of the second cameras 260 for the anode layers AL and one of the second cameras 260 for the cathode layers KL. In each second camera 260, a light source 275, for example a white light source, is provided to illuminate the anode/cathode layer for the image capture by the first camera 260. Depending on the spatial conditions, the second camera 220—as also illustrated in FIG. 1a—is designed as a full-frame camera in order to fully capture the anode/cathode position AL, KL with a single image feed, or the first camera ra 260 is designed as a line scan camera in order to capture the position and/or orientation in x, y, and/or theta of the anode/cathode position while it is being transported to the corresponding pel location 133. The full frame camera can, for example, have a digital image capturing chip 260a with 24 megapixels. Depending on the requirements for accuracy and resolution and spatial conditions, the first camera 260 can also—with appropriate optics, for example a lens 276 and a 90° deflection mirror 277 that is half transparent for the white light—provide a full image feed from below onto the anode/cathode position. The light source 275 can also be pivotably arranged at in order to provide an optimum incidence of light on the respective anode/cathode position AL, KL. For example, the first camera 260 can provide a field of view of the anode/cathode position AL, KL of at least 720×400 mm at a resolution of 134 μm/pixel or verticaler.

A ring light source is arranged in the beam path of the second camera 260, i.e. in the area of the vertical section of the beam path. Light (approx. 600-780 nm) from the ring light source strikes the underside of the anode or cathode at a flat angle, i.e. less than 45 degrees, to enhance the contrast of surface defects.

FIG. 2a shows a variant of an arrangement of the second camera 260. Here, the first camera 260 is also aligned such that during the transport of the anode/Cathode layer, its position and/or orientation (in x, y, and/or theta) is detected in a vertical right view from below with an image feed, shortly before the respective anode/Cathode layer AL, KL arrives at its stacking location 133.

In contrast to the arrangement in FIG. 2, the white light source 275 is shown here between the horizontal right section of the optical path of the camera 260 and the stacking apparatus 138. For this purpose, a further semi-transparent 90° deflection mirror 277a is provided between the camera 260 and the semi-transparent 90° deflection mirror 277 in order to direct the white light into the beam path onto the underside of the stacking apparatus 138 with the anode/cathode position for image capture by the first camera 260. Otherwise, the arrangement of the camera in FIG. 2a corresponds to that in FIG. 2.

Instead of a full image capture by means of a—single—camera, only selected areas, here corner/edge areas of the anode/cathode layer AL, KL can also be captured during their transport with regard to their position and/or orientation (in x, y, and/or theta) in a vertical view from un ten shortly before the respective anode/cathode layer AL, KL arrives at its stacking position 133. For this purpose, as shown in FIG. 2b, two second cameras 260 are used to capture the corner areas of the anode/cathode layer AL, KL vertically from below when the anode/cathode layer AL, KL is transported over them. In particular, one image of the layer KL adhering to the stacking apparatus 138 by means of negative pressure is captured at each corner during transport (“on the fly”), i.e. while the anode/cathode layer Al, KL held on the stacking apparatus is continuously moved to the stacking point 133.

In front of each stacking point there are one or two cameras 260 (on one side) for the anode position AL and one or two cameras 260 (on the other side) for the cathode position KL. For the sake of clarity, only one camera 260 is shown in each of the Figs. While the anode/cathode layers Al, KL held on the stacking apparatus move past the cameras 260, an image of a corner on the front edge of the layer AL or KL is first taken, or two images of the corners on the front edge of the layer AL or KL are first taken. Subsequently, an image of a (preferably diagonal) corner at the rear edge of the layer AL or KL is first taken, or the other two corners at the rear edge of the layer AL or KL are taken with the two cameras 260. From any deviations between the positions of the corners at the front edge and the corners at the rear edge transverse to the transport direction of the respective layer AL or KL, the control unit ECU determines correction values. KL, the control unit ECU determines correction values (in x, y, and/or theta) for the movement and orientation of the stacking apparatus 138 relative to the location/corners of the electrode stack ES, so that the anode/cathode den position AL, KL can be placed vertically on the electrode stack ES very quickly when the stack reaches the stack location 133 with minimal (ideally no) further correction requirements.

In a variant of the stacking apparatuses 138, the holding surface of the gripping tool for picking up and holding an anode/cathode layer AL, KL can be smaller than the surface of an anode/cathode layer AL, KL. For example, the (four) corner areas of the gripping tool can be recessed. Consequently, an anode/cathode layer AL, KL can be illuminated during transport in the corner areas from above, i.e. from the side with the light source 275, which is in contact with the gripping tool. As a result, edges of the cathode layer KL can be detected with particularly vertical contrast compared to the surroundings.

In FIG. 2b, the arrangement of each of the first cameras comprises a matrix camera 260 with a red coaxial ring illumination 266 and/or a blue dark-field illumination 268. The dark-field illumination provides flat (here at an angle of 45° to the optical axis) irradiated light, so that, for example, the edges areas reflect or scatter light towards the camera and then appear clearly contrasted and bright in the camera image.

With such an arrangement, it is possible to capture a square area of approx. 21×21 mm with a resolution of 10.8 μm/pixel or better.

Due to the presence of several neighboring stacking units 130, the inspection of the anode/cathode layers AL, KL can be parallelised.

It may be provided that several anodes for a first group of not immediately neighboring electrode stacks or workpiece carriers 120 in the stacking area 134, e.g. the first workpiece carrier and the third workpiece carrier, are inspected overlapping in time with the respective second camera 260 and/or several cathodes for a second, different from the first, group of not immediately neighboring electrode stacks or workpiece carriers 120 in the stacking area, e.g. workpiece carriers 2 and 4, are inspected overlapping in time with the respective second camera 260.

Since directly neighboring stacking apparatuses 138 move towards each other, i.e. perform opposite movements in the Y-direction, oscillations/vibrations can be compensated and an efficient inspection can be achieved.

Alternatively, it may be provided that the anode layers and the cathode layers are provided in groups at the multiple pick-up points of the respective transport section 210, 310 by the vacuum or adhesive tray 212, 312.

In another variant, the camera 260 inspects the anode and cathode layers in groups. In a variant not shown, for example, a different resolution and a different field of view can be obtained, whereby four cameras 260 can also be set in order to inspect all four corners at the same time, or a line scan camera.

All of the inspection variants described above are used to determine the exact position of the anode/cathode layer AL, KL at least once in order to then correct the alignment prior to removal. By optically detecting the position and alignment of characteristic areas (corners, edges) of the layers AL, KL in the pick-up location and/or during transport to the stacking location 133, and using the data thus obtained won to correct the alignment of the stacking apparatus 138 relative to the electrode stack ES at the stacking location 133 before and/or during transport of the layers AL, KL to the stacking location 133, this depositing is possible in a time-efficient manner and with vertical precision.

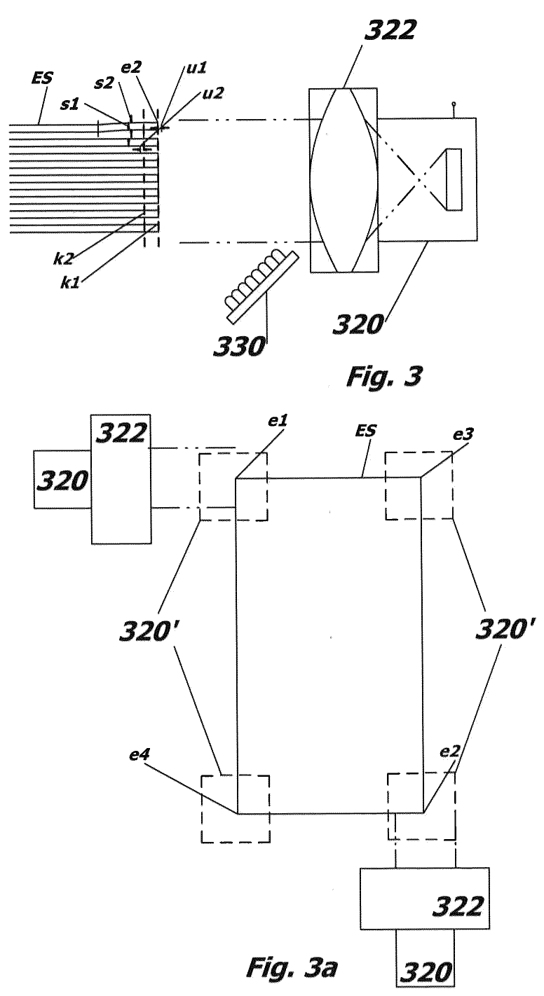

With reference to FIGS. 2 and 3, a further inspection method to be used in the manufacture of modules or precursors of modules is explained below. In a first step, a separated anode/cathode layer AL, KL is provided on a respective vacuum or adhesive tray 212, 312. The separated anode/cathode layer AL, KL is then transported by a stacking apparatus 138 to a stacking point 133. There, the transported anode/cathode layer AL, KL is stacked. At the stacking point 133, an electrode stack ES that has grown around the stacked anode/cathode layer AL, KL at the stacking point 133 is detected in at least one side view and/or including a vertical edge of the electrode stack ES. In a variant of the method, this detection of the side view or a vertical edge of the electrode stack ES provides an image indent. Finally, the alignment direction and/or the position of the or each stacked anode/cathode layer AL, KL relative to the rest of the electrode stack grown at the stacking location is checked.

A position of a stacked anode/cathode layer AL, KL in relation to the other layers of the electrode stack ES is determined, for example, by checking the position/displacement/offset of the individual anode/cathode layers AL, KL relative to one another after the anode/cathode layers AL, KL have been placed on the electrode stack ES. An offset of the individual anode/cathode layers (AL, KL) relative to one another can be determined, for example, by means of an image capture by at least one third camera 320 of at least one (vertical and/or transverse) edge of the electrode stack ES. For example, a resulting image capture can be checked using computer-aided image processing methods by corner/edge search to determine whether one or more of the anode/cathode layers AL, KL of the electrode stack ES protrude laterally or longitudinally above or below the other anode/cathode layers AL, KL, and/or whether a predetermined accuracy was maintained when stacking the anode/cathode layers AL, KL. A variant of the edge search uses a Canny algorithm (Canny edge detector), which provides an image that ideally only contains the edges of the original image.

Alternately stacked anode layers AL and cathode layers KL of the electric tro den stack ES generally have different dimensions. This leads to a stepped (raised) edge in the z-direction in the side view during stacking. This vertical edge or the two vertical edges k1, k2, see FIG. 3, are analysed using the captured image indents. At the stacked anode layers AL and cathode layers KL are examined for their shape and/or dimensions. In other variants, the stacked anode layers AL and cathode layers KL are examined to determine the ch difference between the anode and cathode layers AL, KL and the rest of the anode and cathode layers stack stack ES in terms of the lateral or longitudinal overhang or underhang of each individual layer. A rotation around the vertical axis (in the ta) can also be determined from these overhangs/underhangs (u1, u2 in FIG. 3), or the deviation in the z direction (vertical axis) with which the various de anode/cathode layers (AL, KL) form steps (s1, s2 in FIG. 3) in the electrode stack.

FIGS. 3, 3a illustrate how two third cameras 320 are directed from the side onto diagonally opposite corners e1, e2 and/or their edges k1, k2 (they he FIG. 3) in the vertical axis (z-axis) of the electrode stack ES at the deposit location. In this way, the anode layers (AL) and cathode layers KL stacked on top of each other are used to determine the deviation u1, u2 (see FIG. 3) in the x or y direction (transverse, longitudinal) with respect to the other anode or cathode layers AL, KL of the electrode stack ES with which each individual layer protrudes/declines in the longitudinal and/or transverse direction of the layers. This means that a deviation s1, s2 of the steps (see FIG. 3) in the z-direction (vertical axis) is to be taken into consideration, which is formed by the anode/cathode layers AL, KL lying on top of each other in the electrode stack.

The two third cameras 320 are directly aligned with a vertical edge of the electrode stack. Furthermore, a white spotlight 330 can be used to illuminate the respective edge of the electrode stack ES in order to illuminate the desired position at an angle of approximately 45° to the optical axis of the respective third camera 320.

In a variant shown as a dashed line in FIG. 3a, four third cameras 320′ are directed vertically from above, with spotlights 330 not shown further, onto the four corners e1, e2, e3, e4 of the electrode stack at the deposit point as seen from above. This allows a position of the uppermost stacked anode/cathode layer AL, KL to be determined in relation to at least one underlying layer of the electrode stack ES. The position/rotation/offset of the individual anode/cathode layers AL, KL relative to one another is checked by means of an image capture from each of the four cameras 320′ after the anode/cathode layers AL, KL have been deposited on the electrode stack ES.

With the cameras 320 (see FIG. 3) directed laterally onto the vertical edge of the electrode stack ES, movements of the lifting apparatus 135 with the respective workpiece carrier 120 along the vertical axis (z-axis) can be determined by corresponding processing of the image indents. Before starting to deposit the anode/cathode layers Al, KL to form the electrode stack ES, the x, y positions of the workpiece carrier at different z heights are thus detected with the third cameras 320 from image indents obtained in the process. The resulting data is stored for comparison with x, y positions of the workpiece carrier at different z heights during deposition of the anode/cathode layers in order to check whether the anode/cathode layers have been stacked within a predetermined accuracy at the x, y position corresponding to the respective z position of the work piece carrier on the lifting apparatus 135. In a variant, the data obtained above is used to correct the orientation in the direction of rotation about the z-axis (vertical axis) (in theta) when picking up the anode/cathode layers with the stacking apparatus 138.

From the processed data of the image captures from the cameras, in particular at least one of the third cameras, it is also provided in a variant to use the stacking apparatus 138 to pick up an incorrectly deposited layer from the electrode stack ES again and optionally to deposit it correctly on the electrode stack again, or to transport it to a position at which it is discarded.

The variants of the apparatus described above, their structural and operational aspects as well as the variants of the method are merely intended to provide a better understanding of the structure, the mode of operation and the properties; they do not limit the disclosure et al. to the embodiments. The figures are partly schematic. Essential properties and effects are shown, in some cases clearly enlarged, in order to clarify the functions, operating principles, technical designs and features. Each mode of operation, each principle, each technical embodiment and each feature disclosed in the Fig. or in the text can be freely and arbitrarily combined with all claims, each feature times in the text and in the other Fig., other modes of operation, principles, technical embodiments and features contained in this disclosure or resulting therefrom, so that all conceivable combinations can be assigned to the procedure described. This also includes combinations between all individual embodiments in the text, i.e. in each section of the description, in the claims and also combinations between different variants in the text, in the claims and in the figures. Nor do the claims limit the disclosure and thus the possible combinations of all the features disclosed. All disclosed features are also explicitly disclosed here individually and in combination with all other features.

1. An inspection method in the manufacture of modules or precursors of modules comprises the steps of:
providing a separated anode/cathode layer (AL, KL);
transporting the anode/cathode layer (AL, KL) to a stacking location (133) by a stacking apparatus (138);
stacking the transported anode/cathode layer (AL, KL) at the stacking location (133);
detecting a stack of electrodes (ES) grown by the stacked anode/cathode layer (AL, KL) at the stacking location (133) in at least one side view and/or including a vertical edge of the stack of electrodes (ES) at the stacking location (133); and
checking the orientation and/or position of the stack of electrodes (ES) at the stacking location (133); and
checking the orientation and/or position of the or each stacked anode/cathode layer (AL, KL) relative to the rest of the electrode stack (ES) grown at the stacking location (133).

2. The inspection method according to claim 1, in which
a position of a stacked anode/cathode layer (AL, KL) in relation to the other layers of the electrode stack (ES) is determined by checking the position/a rotation/an offset of the individual anode/cathode layers (AL, KL) in relation to one another after the anode/cathode layers (AL, KL) have been placed on the electrode stack (ES), and/or wherein
an offset of the individual anode/cathode layers (AL, KL) in relation to one another is determined with an image capture of at least one third camera from at least one (vertical and/or transverse) edge of the electrode stack (ES), and/or wherein
a resulting image capture is determined by an image capture of at least one third camera from at least one (vertical and/or transverse) edge of the electrode stack (ES), KL) is determined with an image capture of at least one third camera from at least one (vertical and/or transverse) edge of the electrode stack (ES), and/or wherein
an image capture obtained is checked by corner/edge search to determine whether one or more of the anode/cathode layers (AL, KL) of the electrode stack (ES) protrude above or below the other anode/cathode layers (AL, KL), and/or whether an accuracy was maintained when stacking the anode/cathode layers (AL, KL).

3. The inspection method according to claim 1 or 2, in which alternately stacked anode layers (AL) and cathode layers (KL) of the electrode stack(ES) have different dimensions with a (vertical) edge stepped in the z-direction in the side view, the shape and/or dimensions of the stacked anode layers (AL) and cathode layers (KL) being examined; and/or wherein the anode layers (AL) and cathode layers (KL) stacked on top of one another are examined to determine the deviation from the other of the anode layers (AL) and cathode layers (KL); and/or the deviation in the z-direction (vertical axis) with which the various anode/cathode layers (AL, KL) form steps in the electrode stack is examined.

4. The inspection method according to one of claims 1 to 3, in which
by means of at least two third cameras (320) are directed from the side onto diagonally opposite corners (e1, e2) and/or their edges (k1, k2) in the vertical axis (z-axis) of the electrode stack ES at the deposit location in order to examine, on the anode layers (AL) and cathode layers (KL) stacked on top of one another, the deviation (u1, u2) in the x or y direction (transverse, longitudinal) with respect to the rest of the anode or cathode layers (AL, KL). cathode layers (AL, KL) of the electrode stack (ES); and/or to investigate the deviation in the z-direction (vertical axis) with which the various anode/cathode layers (AL, KL) form steps in the electrode stack.

5. The inspection method according to claim 4, in which
the at least two third cameras (320) are aligned with a (vertical) edge of the electrode stack, and/or spotlights (330) are used to illuminate the respective edge of the electrode stack (white) in order to illuminate the desired position.

6. The inspection method according to any one of the preceding claims, wherein
four third cameras are directed to the four corners of the electrode stack at the deposit location, as seen from above, in order to determine a position of the uppermost stacked anode/cathode layer (AL, KL) in relation to at least one underlying layer of the electrode stack (ES) by checking the position/rotation/offset of the individual anode/cathode layers (AL, KL) relative to one another after the anode/cathode layers (AL, KL) have been deposited on the electrode stack (ES), by means of an image capture from each of the four cameras.

7. The inspection method according to any one of the preceding claims, wherein
movements of the lifting apparatus (135) with a respective workpiece carrier (120) along the vertical axis (z-axis) and inaccuracies thereof are taken into account by detecting x-, y-positions of the workpiece carrier at different z-heights with the third cameras (320) before the depositing of the anode/cathode layers (Al, KL) to form the electrode stack (ES) starts, and the corresponding data are stored for comparison with x-, y positions of the workpiece carrier at different z heights during the deposition of the anode/cathode layers to check whether the anode/cathode layers have been stacked within the accuracy at the x, y position, which corresponds to the respective z-position of the work piece carrier on the lifting apparatus, and/or for correcting the orientation in the direction of rotation about the z-axis (vertical axis) (in theta) when picking up the anode/cathode layers with the stacking apparatus.

8. The inspection method according to any one of the preceding claims, wherein a plurality of isolated anode layers (AL) and a plurality of isolated cathode layers (KL) corresponding to the number of stacking units (130) are provided in the stacking area (134) in groups at pick-up locations (221, 321).

9. An apparatus for conveying and inspecting modules or precursors of modules, comprising:
a pick-up point (221, 321) for providing a separated anode/cathode layer (AL, KL);
a stacking apparatus (138), intended and arranged for
transporting the anode/cathode layer (AL, KL) to a stacking point (133) and
stacking the transported anode/cathode layer (AL, KL) at the stacking point (133);
a camera (320), intended and arranged for capturing an image feed of an electrode stack (ES) grown by the stacked anode/cathode layer (AL, KL) at the stacking point (133) in at least one side view and/or including a vertical edge in the z-direction of the electrode stack (ES) at the stacking point (133); and
a control unit (ECU), intended and arranged to determine from the image capture of the second camera the orientation and/or position of the or each stacked anode/cathode layer (AL, KL) relative to the rest of the electrode stack (ES) grown at the stacking location (133).

10. The apparatus according to claim 9, wherein
the control unit (ECU) is intended and arranged to determine a position of a stacked anode/cathode layer (AL, KL) in relation to the other layers of the electrode stack (ES), by checking the position/rotation/offset of the individual anode/cathode layers (AL, KL) relative to one another after the anode/cathode layers (AL, KL) have been placed on the electrode stack (ES); and/or wherein
the control unit (ECU) is intended and arranged to determine an offset of the individual anode/cathode layers (AL, KL) relative to one another with an image capture of at least one third camera from at least one (vertical and/or transverse) edge of the electrode stack (ES);
and/or wherein
the control unit (ECU) is intended and arranged to check an image capture obtained by corner/edge search as to whether one or more of the anode/cathode layers (AL, KL) of the electrode stack (ES) protrude above or below the other anode/cathode layers (AL, KL), and/or whether an accuracy was maintained when stacking the anode/cathode layers (AL, KL).

11. The apparatus according to claim 9 or 10, wherein
the control unit (ECU) is intended and arranged to determine different dimensions with a (vertical) edge stepped in the z-direction in the side view from the image feed in alternation of anode layers (AL) and cathode layers (KL) of the electrode stack (ES) stacked on top of one another, and to examine the shape and/or dimensions of the anode layers (AL) and cathode layers (KL) stacked on top of one another; and/or wherein
the control unit (ECU) is intended and arranged to examine the anode layers (AL) and cathode layers (KL) stacked on top of one another to determine the deviation from the other of the anode layers (AL) and cathode layers (KL). layers (AL, KL) of the electrode stack (ES);
and/or
the control unit (ECU) is intended and arranged to analyse an image feed to determine the deviation in the z-direction (vertical axis) with which the various anode/cathode layers (AL, KL) form steps in the electrode stack.

12. The apparatus according to one of the preceding apparatus claims, wherein
the control unit (ECU) is intended and arranged to receive image feeds from at least two third cameras (320) which, as seen from above, contain diagonally opposite corners (e1, e2) and/or their edges (k1, k2) in the vertical axis (z-axis) of the electrode stack ES at the deposit location in order to examine the anode layers (AL) and cathode layers (KL) stacked on top of one another to determine the deviation (u1, u2) in the x or y direction (transverse, longitudinal) with respect to the other anode or cathode layers (AL, KL). cathode layers (AL, KL) of the electrode stack (ES) in the longitudinal and/or transverse direction of the layers; and/or to investigate with which deviation in the z-direction the various anode/cathode layers (AL, KL) form steps in the electrode stack.

13. The apparatus according to one of the preceding apparatus claims, wherein
the at least two third cameras (320) are aligned with a (vertical) edge of the electrode stack, and/or spotlights (330) illuminate the desired position on the electrode stack (ES) in order to illuminate the respective edge of the electrode stack.

14. The apparatus according to any one of the preceding apparatus claims, wherein
the control unit (ECU) is intended and arranged to receive from at least four third cameras (320) image captures containing the four corners of the electrode stack at the deposit location, as viewed from above, in order to determine a position of the uppermost stacked anode/cathode layer (AL, KL) in relation to at least one underlying layer of the electrode stack (ES) by checking the position/rotation/offset of each of the anode/cathode layers (AL, KL) relative to one another after the anode/cathode layers (AL, KL) have been deposited on the electrode stack (ES), by means of an image capture from each of the four cameras.

15. The apparatus according to one of the preceding apparatus claims, wherein
the control unit (ECU) is intended and arranged to take into account movements of the lifting apparatus (135) with a respective workpiece carrier (120) along the vertical axis (z-axis) and inaccuracies thereof, in that, before the start of depositing the anode/cathode layers (Al, KL) to form the electrode stack (ES), the x, y positions of the work piece carrier at different z heights are detected by means of the third cameras (320) by means of image feeds, the corresponding data are stored in a data memory for comparison with x-, y-positions of the workpiece carrier at different z-heights during the stacking of the anode/cathode layers to check whether the anode/cathode layers have been stacked within the accuracy at the x-, y-position corresponding to the respective z-position of the workpiece carrier on the lifting apparatus, and/or for correcting the orientation in the direction of rotation about the z-axis (vertical axis) (in theta) when picking up the anode/cathode layers with the stacking apparatus.

16. The apparatus according to one of the preceding apparatus claims, wherein
a respective transport section (210, 310) with vacuum or adhesive trays (212, 312) is intended and arranged to provide a plurality of individual anode layers (AL) and a plurality of individual cathode layers (KL) corresponding to the number of stacking units (130) in the stacking region (134) at pick-up points (221, 321) in groups.
